(19) United States
(12) Patent Application Publication
(10) Pub. No.: US 2023/0319456 A1
(43) Pub. Date: Oct. 5, 2023

(54) anti-loss neck rope for wireless earphones

(71) Applicant: Sheng Xie, Shenzhen (CN)

(72) Inventor: Sheng Xie, Shenzhen (CN)

(21) Appl. No.: 18/320,237

(22) Filed: May 19, 2023

(30) Foreign Application Priority Data
Apr. 7, 2023 (CN) 202320742216.X

(51) Int. Cl. H04R 1/10

(52) U.S. Cl. CPC H04R 1/1091

(57) ABSTRACT

The present disclosure relates to a wireless headset accessory, specifically an anti-loss neck rope for wireless earphones, including a connecting rope and two sets of mounting heads. The two sets of mounting heads are correspondingly fixed on both sides of the connecting rope, the mounting head is provided with a communicating hole for placing wireless earphones, the communicating hole is provided with a fastener, and a group of magnetic attraction pieces is respectively installed in the two sets of mounting heads. The present disclosure magnetically fixes the mounting head through two sets of magnetic attraction pieces to reduce the shaking of the mounting head when the person moves, and at the same time, the two ends of the connecting rope are fixed to refrain the currently used anti-loss neck rope hanging on the neck from hanging other objects and slipping and getting lost.

### TECHNICAL FIELD

The present disclosure relates to a wireless earphone accessory, specifically an anti-loss neck rope for wireless earphones.

### DESCRIPTION OF THE RELATED ART

Earphones are a pair of conversion units that accept electrical signals from a media player or receiver and convert them into audible sound waves using speakers close to the ear.

Earphones can be separated from the media player and can be connected with only one plug, allowing you to listen to the sound alone without affecting others. At the same time, with the advancement of technology, wireless earphones without the use of cables have been invented, which greatly improves the convenience of using earphones.

When the wireless earphones are in use, an additional charging case is required to store and charge the wireless earphones. In fact, when using wireless earphones, it is only necessary to remove the wireless earphones briefly. At this time, the operation of restoring them in the charging case is more troublesome to avoid the loss of the wireless earphones. In order to solve the above problems, the designer has designed an anti-loss neck rope, installed a pair of wireless earphones on both ends of the anti-loss neck rope, and hung the anti-loss neck rope on the chest for use.

When the currently used anti-loss neck rope is hung on the neck not used, it is easy to hang other objects and slip and get lost.

### PRESENT DISCLOSURE

The present disclosure aims to provide an anti-loss neck rope for wireless earphones, which is used to solve the problem that the currently used anti-loss neck rope is easy to hang other objects and slip and get lost when it is not used in the neck.

In order to achieve the above objective, the present disclosure provides an anti-loss neck rope for wireless earphones, which includes a connecting rope and two sets of mounting heads. The two sets of mounting heads are correspondingly fixed on both sides of the connecting rope, the mounting head is provided with a communicating hole for placing wireless earphones, a fastener is provided in the communicating hole, and a group of magnetic attraction pieces is respectively installed in the two sets of mounting heads, and the mounting head is magnetically fixed by the two sets of magnetic attraction pieces.

As a further solution of the present disclosure, the fastener is a silicone ring, and a placement groove for placing the silicone ring is arranged in the communicating hole.

As a further solution to the present disclosure, the connecting rope is a silicone rope, and both ends of the silicone rope are fixedly connected with the corresponding mounting head.

As a further solution of the present disclosure, the magnetic attraction member is a magnet, and the magnet is fixedly installed inside the mounting head.

Compared with the prior art, the present disclosure designs a connecting rope and two sets of mounting heads, and a pair of wireless earphones are fixedly installed in the mounting holes of the two sets of mounting heads. When the person is not wearing the wireless earphones, the two sets of mounting heads are magnetically fixed this time to avoid the situation that the currently used anti-loss neck rope easily hangs other objects and slips and gets lost when it is not used in the neck.

### DRAWING DESCRIPTION

FIG. 1 is a schematic structural diagram of an anti-loss neck rope for wireless earphones provided by the present disclosure.

FIG. 2 is an enlarged schematic diagram of A in FIG. 1 provided by the present disclosure.

In the drawings: 1. Connecting rope; 2. Mounting head; 201. Silicone ring; 202. Magnet.

### DESCRIPTION OF THE PREFERRED EMBODIMENT

The technical solution of the present disclosure will be described in further detail below in conjunction with the description of the preferred embodiment.

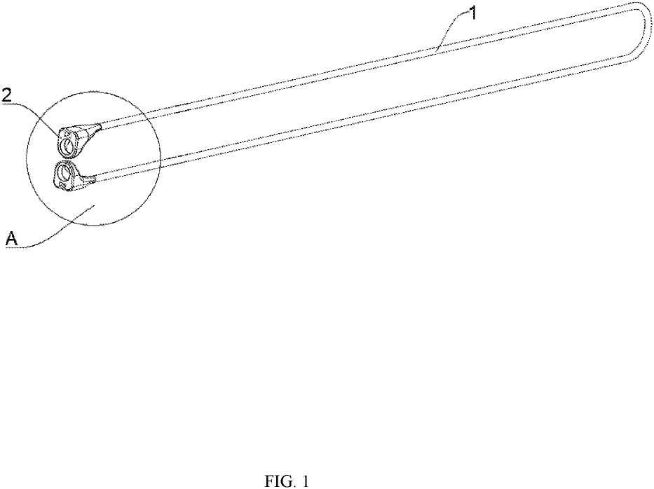

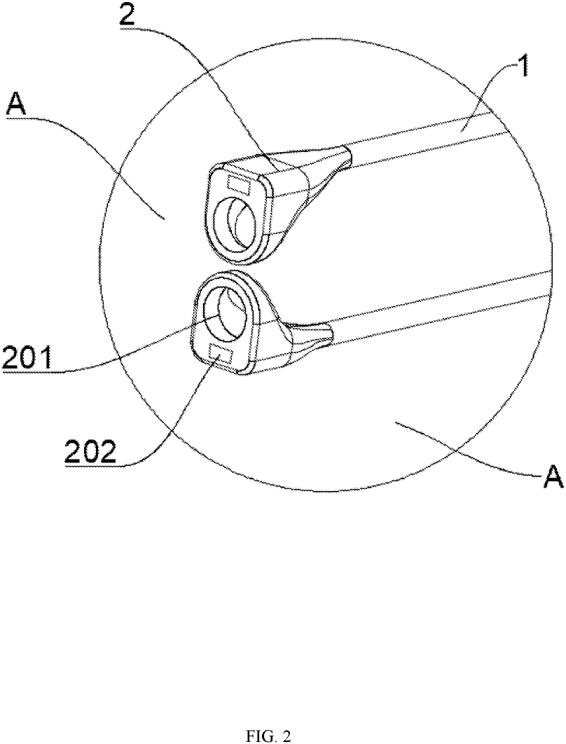

As shown in FIG. 1 and FIG. 2, in the embodiment of the present disclosure, an anti-loss neck rope for wireless earphones includes a connecting rope 1 and two sets of mounting heads 2. The two sets of mounting heads 2 are correspondingly fixed on both sides of the connecting rope 1, the mounting head 2 is provided with a communicating hole for placing the wireless earphone, the communicating hole is provided with a fastener, and a group of magnetic attraction pieces is respectively installed in the two sets of mounting heads 2, and the mounting head 2 is magnetically fixed by the two sets of magnetic attraction pieces;

In the present disclosure, according to the wireless earphones’ specifications, the fastener of the corresponding specifications is selected to be fixed in the communicating hole, and the wireless earphones are inserted into the corresponding communicating holes for fixing. When the person takes off the wireless earphones, close the two sets of mounting head 2, and fix to attract the two sets of mounting head 2 through the magnetic attraction pieces.

As shown in FIG. 2, in the embodiment of the present disclosure, the fastener is a silicone ring 201, and the communicating hole is provided with a placement groove for placing the silicone ring 201. The hole inside the silicone ring 201 and the outer wall of the wireless earphone are frictionally fixed, and the suitable silicone ring 201 can be selected according to the size of the wireless earphone to meet the fixing requirements of different specifications of wireless earphones.

As shown in FIG. 1, in the embodiment of the present disclosure, the connecting rope 1 is a silicone rope, and both ends of the silicone rope are fixedly connected with the corresponding mounting head 2.

As shown in FIG. 2, in the embodiment of the present disclosure, the magnetic attraction piece is a magnet 202, and the two sets of magnets 202 are fixedly installed inside the corresponding mounting head 2. In the present disclosure, the two sets of mounting heads 2 are magnetically fixed by the two sets of magnets 202, and at the same time, when the magnetic attraction is fixed, the two sets of mounting heads 2 are positioned.

Based on the above, the present disclosure designs the connecting rope 1 and the two sets of mounting heads 2, and a pair of wireless earphones are fixedly installed in the mounting holes of the two sets of mounting heads 2. When the person is not wearing the wireless earphones, the two sets of mounting heads 2 can be magnetically fixed at this time to avoid the situation that the currently used anti-loss neck rope easily hangs other objects and slips and gets lost when it is not used in the neck.

In the description of the present disclosure, it should be noted that, unless otherwise expressly specified and limited, the terms “installed”, “connected” and “connected” should be understood broadly. For example, it can be fixedly connected, detachably connected, or integrally connected; it can be mechanically connected or electrically connected; it can be directly connected, it can be indirectly connected through an intermediate medium, or it can be a communication between two elements. For those of ordinary skill in the art, the specific meaning of the above terms in the present disclosure can be understood through specific circumstances.

The preferred embodiments of the present disclosure have been described in detail above, but the present disclosure is not limited to the above-mentioned embodiments, and within the scope of knowledge possessed by those of ordinary skill in the art, various changes can be made under the premise.

1. An anti-loss neck rope for wireless earphones, characterized in that it includes a connecting rope and two sets of mounting heads. The two sets of mounting heads are correspondingly fixed on both sides of the connecting rope, the mounting head is provided with a communicating hole for placing wireless earphones, a fastener is provided in the communicating hole, and a group of magnetic attraction pieces is respectively installed in the two sets of mounting heads, and the mounting head is magnetically fixed by the two sets of magnetic attraction pieces.

2. The anti-loss neck rope for wireless earphones according to claim 1, wherein the fastener is a silicone ring, and the communicating hole is provided with a placement groove for placing the silicone ring.

3. The anti-loss neck rope for wireless earphones according to claim 1, wherein the connecting rope is a silicone rope, and both ends of the silicone rope are fixedly connected with the corresponding mounting head.

4. The anti-loss neck rope for wireless earphones according to claim 1, wherein the magnetic attraction member is a magnet, and the magnet is fixedly installed inside the mounting head.
